(19) United States
(12) Patent Application Publication
(10) Pub. No.: US 2023/0385970 A1
(43) Pub. Date: Nov. 30, 2023

(54) SYSTEM AND METHOD FOR PLANNING FINAL ARRANGEMENTS WITH DIGITAL ASSET CONTENT DISTRIBUTION

(71) Applicant: My Planning Place LLC, Cameron Park, CA (US)

(72) Inventor: Silvio REGGIARDO, III, Cameron Park, CA (US)

(21) Appl. No.: 18/233,032

(22) Filed: Aug. 11, 2023

Related U.S. Application Data
(63) Continuation-in-part of application No. 18/119,141, filed on Mar. 8, 2023.
Application No. 18/119,141 is a continuation-in-part of application No. 18/119,141, filed on Mar. 8, 2023.
(60) Provisional application No. 63/372,359, filed on Mar. 8, 2022.
(60) Provisional application No. 63/628,020, filed on Jun. 14, 2023.

(51) Int. Cl. G06Q 50/18; G06Q 10/1093

(52) U.S. Cl. CPC G06Q 50/186; G06Q 10/1093; G06Q 2220/00

(57) ABSTRACT

A system and method for planning final arrangements with digital asset content distribution are disclosed. A particular embodiment is configured to: enable a custodian to receive access to digital asset content and distribution instructions from a digital asset owner platform; enable the custodian to receive an authenticated agreement advising the custodian of identifying information for a designated recipient platform to receive the digital asset content upon death or incapacitation of a corresponding digital asset owner, the authenticated agreement also advising the custodian of identifying information for a death reporting entity; enable the custodian to receive an indication of the death or incapacitation of the digital asset owner from the death reporting entity; enable the custodian to distribute the digital asset content to the designated recipient platform in response to receiving the indication of the death or incapacitation of the digital asset owner from the death reporting entity; enable the custodian to receive a first integrity check or authenticated receipt verifying that the designated recipient platform received the distributed digital asset content; enable the designated recipient platform to distribute the digital asset content to at least one ultimate recipient; enable the designated recipient platform to receive a second integrity check or authenticated receipt verifying that the at least one ultimate recipient received the distributed digital asset content; enable the custodian to receive the second integrity check or authenticated receipt verifying that the at least one ultimate recipient received the distributed digital asset content; enable the designated recipient platform to distribute final arrangements information to at least one ultimate recipient responsible for final arrangements; and use scheduling software and a data processor to prepare a final arrangements event schedule using the final arrangements information.

### PRIORITY PATENT APPLICATIONS

This non-provisional continuation-in-part (CIP) patent application draws priority from U.S. non-provisional patent application Ser. No. 18/119,141; filed Mar. 8, 2023, which draws priority from U.S. provisional patent application Ser. No. 63/372,359; filed Mar. 8, 2022. This non-provisional CIP patent application also draws priority from U.S. provisional patent application Ser. No. 63/628,020; filed Jun. 7, 2023. This present non-provisional CIP patent application draws priority from the referenced patent applications. The entire disclosure of the referenced patent applications is considered part of the disclosure of the present application and is hereby incorporated by reference herein in its entirety.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the disclosure, software, and data as described below and in the drawings that form a part of this document: Copyright 2022-2023, My Planning Place LLC, All Rights Reserved.

### TECHNICAL FIELD

This patent application relates to electronic devices and computer-implemented software systems, data collection, storage, and distribution systems, according to example embodiments, and more specifically to a system and method for planning final arrangements with digital asset content distribution.

### BACKGROUND

The Uniform Law Revision Commission's Revised Uniform Fiduciary Access to Digital Assets Act of 2015 (“RUFADAA”) is a set of model digital asset disclosure statutes nearly every state has adopted to the extent relevant for an example embodiment (section references below are to RUFADAA and equivalent state statutes). People tend to store personal, financial and estate planning information in disparate places—some in digital form (often password protected) and some as hard copies in file cabinets or safer places. Absent an urgent need to organize information for final arrangements, people tend not to think very far ahead, especially about disturbing or otherwise challenging topics like their mortality. When they die, loved ones or others responsible for dealing with final arrangements and estate administration often scramble to find and organize information at an urgent and stressful time. RUFADAA now provides a legal framework for distributing cloud-based digital asset information after the digital asset owner's death. Digital asset distribution services within the RUFADAA framework have started to emerge. A society that increasingly relies on the Internet will use those services, and more of these services will become available. RUFADAA can apply to both cloud data storage and locally-stored data; as such, example embodiments also relate to cloud data storage and locally-stored data.

RUFADAA deals with the disclosure and distribution of digital assets, not digital asset title transfers. RUFADAA is a “revised” act because the initial model legislation failed to gain broad state acceptance. RUFADAA achieved that acceptance. The Uniform Law Commission is very unlikely to revise RUFADAA in the foreseeable future, because RUFADAA has created the desired national uniformity in digital asset distribution laws. Amendment would create chaos as states decide whether to adopt proposed amendments. An example embodiment, through the use of modern cryptography, provides a practical technological solution to a technical problem. It is a problem arising from the legal framework governing digital asset content distribution—a problem that will only grow worse as estate planners for digital asset owners increasingly address RUFADAA through disclosure and non-disclosure directions in estate planning documents.

### The Problems

People can have very different views regarding the final arrangements they want, but they typically do not want to simply foist final arrangements obligations on family or friends. Many people have detailed plans in mind. Some pre-fund certain final arrangements. However, except in the case of imminent death there is no practical way to know what final arrangements schedules will apply, what final arrangements will likely cost, or even what final arrangements options will exist. And even when people store detailed final arrangements information and instructions with a RUFADAA custodian, the typical approach to distributing digital asset content under current digital asset distribution arrangements is to simply name a person or people who will receive access to that information without any instructions (at least not instructions to the custodian) regarding what the information recipient(s) must do with the information. A recipient who simply receives but does not take control of and manage digital asset information is not a “designated recipient” under the highest RUFADAA content distribution tier discussed below. This distribution approach exposes the distributing custodian to the risk that the disclosure is improper (and liability may result) because as discussed below the user's estate planning documents may have contrary instructions and override the instructions to the custodian. The present invention is intended to solve these problems for the user, the custodian and those the user selects to procure final arrangements goods and/or services and also schedule final arrangements activities.

With respect to the distribution of a deceased owner's digital asset information, RUFADDA now provides a legal framework to both (a) protect digital asset custodians from improperly disclosing confidential information, and (b) allow deceased owners' executors or other successors to compel the distribution of important information.

RUFADDA creates a three-tiered distribution direction hierarchy that can put custodians in a real bind. A deceased owner's estate planning document directions regarding digital asset content disclosure or non-disclosure can override inconsistent disclosure or non-disclosure directions in a terms-of-service agreement between a custodian and a digital asset owner. Custodians cannot know whether in complying with a terms-of-service agreement's disclosure terms they are complying with RUFADAA, and thus receiving its protections, without first making good faith inquiries regarding whether potentially overriding estate planning documents exist (and, if so, reviewing the relevant content). This provides a practical constraint—a chilling effect—on the prompt distribution of digital asset information that could be most useful for a deceased owner's final arrangements.

### SUMMARY

In various example embodiments described herein, a system and method for planning final arrangements with digital asset content distribution are disclosed. In the various example embodiments described herein, a computer-implemented tool or software application (app) as part of a digital asset distribution system is described to automate and improve the distribution or disclosure of digital assets upon the death of a digital asset owner. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, consumer electronic devices, or any other type of computing, data processing, communication, networking, or electronic system.

In various example embodiments described herein, a digital asset distribution system and method is described for planning a decedent's final arrangements with digital asset content distributions within the structure of the Uniform Law Commission's Revised Uniform Fiduciary Access to Digital Assets Act of 2015 (“RUFADAA”), as adopted by various states, using modern cryptography.

A certain death leads to final arrangements nearly as certain. Final arrangements involve a broad range of activities, from disposing of the decedent's body to funeral services or memorials that can be expensive and require significant schedule coordination. Many people want to plan (and sometimes pre-fund) their final arrangements to the extent reasonably possible. Now, they can store the relevant information as RUFADAA digital assets in the cloud with a custodian for disclosure when required. This system and method disclosed herein can have the following three primary objectives (words in quotes immediately below are RUFADAA defined terms):
1. assist a “user” in final arrangements planning and budgeting while storing final arrangements information as “digital assets” in the cloud with a “custodian”;
2. provide for prompt distribution of the final arrangements information to a “designated recipient” following the user's death, as the user directed in an “online tool,” in a manner that assures the custodian the distribution is RUFADAA-compliant and overrides any inconsistent disclosure instructions in the user's estate planning documents; and
3. help a designated recipient or others the user chose to carry out final arrangement activities procure the related goods and/or services in an efficient manner.

This system and method may also involve scheduling final arrangements activities with scheduling software, funding some or all final arrangements, and even providing a record for use of those funds. Through the use of conditional computer instructions and modem cryptography, this process will be instantaneous, entirely automated, and secure. It will also provide evidence of proper data transfers. This process will use computer systems and data networks. It may involve the following steps or stages consistent with the above-referenced three primary objectives:
1. The user will plan final arrangements with software including artificial intelligence (AI) and standard Internet data extraction applications (e.g., web scraping) and then store final arrangements information with a custodian as cloud-based encrypted final arrangements digital asset content.
2. Pursuant to online tool instructions the user could have modified or deleted at any time (placing the process in the top RUFADAA digital asset content distribution tier), upon receipt of user death notice in a predetermined manner the custodian will distribute a copy or cause a copy of that content to be distributed to a third party who will take control of and administer those final arrangements digital assets by (a) using a decryption key and handling final arrangement goods and/or services procurement; or (b), if directed in the online tool, by providing a copy of that content and a decryption key to at least one ultimate recipient to carry out those tasks.
3. The designated recipient or ultimate recipient(s) responsible for carrying out final arrangement goods and/or services procurement will receive access to software that will operate on that final arrangements information (along with any other relevant information manually input at the time) and with AI and standard Internet data extraction applications will help locate and procure final arrangements goods and/or services. Additional software may also help schedule final arrangements activities. And other software may help pay and account for those goods and/or services.

The various example embodiments described herein will solve the current problems with digital asset distribution by ensuring that the deceased owner's instructions override any contrary estate planning document directions. This will allow custodians to promptly distribute digital asset information as the deceased owner directed. It will further allow the distribution under a fully automated, instant and secure process that uses modern cryptography. As a result, custodians will receive legal protections for disclosure under RUFADAA. After providing the custodian agreed-upon evidence of the user's death, user designated recipients to whom the user directed asset or information disclosure will promptly receive the disclosure exactly as the user directed.

Pursuant to online tool instructions the user could have modified or deleted at any time, upon receipt of user death notice in a predetermined manner, the custodian will distribute or cause a copy of that content to be distributed to a third party who will take control of and administer those final arrangements digital assets by (a) using a decryption key and handling final arrangement goods and/or services procurement and scheduling; or (b), if directed in the online tool, by providing a copy of that content and a decryption key to at least one additional party (ultimate recipient) to carry out those tasks. Either approach will place the process in the top RUFADAA digital asset content distribution tier and thus meet the objective of assuring the custodian that the content distribution is RUFADAA-compliant and overrides any inconsistent disclosure instructions in the user's estate planning documents.

However, the various example embodiments described herein add two critical features. First, the user will plan final arrangements with software including AI and standard Internet data extraction applications (e.g., web scraping) and then store final arrangements information with a custodian as cloud-based encrypted final arrangements digital asset content. This part of the process will satisfy the objective of assisting the user in final arrangements planning and budgeting while also taking advantage of RUFADAA benefits. Second, the designated recipient or ultimate recipient(s) responsible for carrying out final arrangement goods and/or services procurement and scheduling will receive access to software that will operate on that final arrangements information (along with any other relevant information manually input at the time) and with AI and standard Internet data extraction applications will help locate available and price-competitive final arrangements goods and service providers. Optional features can involve using scheduling software to efficiently schedule final arrangements activities. This part of the process will satisfy the objective of helping a designated recipient or others the user chose to carry out final arrangement activities schedule those activities and procure the related goods and/or services in an efficient manner. Additional optional features can involve pre-funding final arrangements and tracking related payments.

Details of the various example embodiments disclosed herein are provided below and in the accompanying drawings.

### BRIEF DESCRIPTION OF THE DRAWINGS

The various embodiments are illustrated by way of example, and not by way of limitation, in the figures of the accompanying drawings in which:

FIG. 1 illustrates an example embodiment of a networked system in which various embodiments may operate;

FIG. 2 illustrates an alternative example embodiment of a networked system in which various embodiments may operate;

FIG. 3 illustrates a schematic relating to the information flow between parties for an example embodiment, in which the custodian manages the distribution of the digital asset content;

FIG. 4 illustrates another example embodiment of a networked system in which various embodiments may operate;

FIG. 5 illustrates a processing flow diagram that illustrates an example embodiment of a method as described herein; and

FIG. 6 shows a diagrammatic representation of a machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In various example embodiments described herein, a system and method for planning final arrangements with digital asset content distribution are disclosed. In the various example embodiments described herein, a computer-implemented tool or software application (app) as part of a digital asset distribution system is described to automate and improve the distribution or disclosure of digital assets upon the death of a digital asset owner. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, consumer electronic devices, or any other type of computing, data processing, communication, networking, or electronic system.

In various example embodiments described herein, a digital asset distribution system is described for distributing digital asset content within the structure of the Uniform Law Revision Commission's Revised Uniform Fiduciary Access to Digital Assets Act of 2015 (“RUFADAA”), as adopted by various states, using modern cryptography. The described system and method is intended to give digital asset custodians assurance they are distributing deceased digital asset owners' digital asset content in compliance with RUFADAA, without concerns that the digital asset owners' estate planning document or other directions override (and render non-compliant) the digital asset owners' directions to the custodian. The described system and method allow RUFADAA-compliant digital asset content distribution promptly as the owner directed following a digital asset owner's death.

### Legal Protections of Good Faith RUFADAA Compliance

RUFADAA both (a) allows a deceased user's (i.e., digital asset owner's) successors to enforce the user's digital asset disclosure and non-disclosure instructions, and (b) gives custodians legal protection for compliance. With respect to that custodian protection, Section 16(f) provides that a custodian is “immune from liability for an act or omission done in good faith in compliance with this [act].” The legal protection custodians receive from RUFADAA compliance is an important aspect of an example embodiment's solution to a practical technological problem. As used herein, the term “deceased user” or “RUFADAA user” refers to a digital asset owner (or someone legally empowered to act on behalf of the digital asset owner) who has died and for whom the release or distribution of the deceased owner's digital assets becomes an issue that needs to be resolved using the technology disclosed herein.

### Certain Critical RUFADAA Definitions

RUFADAA definitions are critical to an example embodiment, which depends on digital asset content disclosure directions a RUFADAA “user” gives to a RUFADAA “custodian” in an “online tool.” Section 2(10) broadly defines a “digital asset” as “an electronic record in which an individual (i.e., owner) has a right or interest . . . ” Section 2(26) defines a “user” as “a person that has an account with a custodian.” Section 2(8) defines a “custodian” as “a person that carries, maintains, processes, receives, or stores a digital asset of a user (i.e., owner).” Section 2(1) defines an “account” as “an arrangement under a terms-of-service agreement in which a custodian carries, maintains, processes, receives, or stores a digital asset of the user (i.e., owner) or provides goods or services to the user (i.e., owner).” Section 2(24) defines a “terms-of-service agreement” as “an agreement that controls the relationship between a user (i.e., owner) and a custodian.”

### Disclosure Priority Under RUFADAA

Under Section 2(24), custodians and digital asset owners may by a terms-of-service agreement generally agree upon digital asset content disclosures or distributions the custodian will make or withhold following a digital asset owner's death. Section 4, however, relegates that agreement's disclosure directions to the bottom of the following hierarchy:
(1) “online tool” directions for disclosure to a “designated recipient”, wherein the digital asset owner may modify or delete the directions at any time,
(2) estate planning document directions regarding disclosure to a “fiduciary,” (e.g., executor or trustee), and
(3) terms-of-service agreement directions.

This means, for example, while the terms-of-service agreement may provide that following the custodian's receipt of predetermined user death evidence the custodian will disclose the user's digital asset content to individuals A, B, and C, none of whom has any duty to administer the digital assets, a conflicting direction to disclose digital asset content to a fiduciary in an estate planning document will take precedence. For example, if one of the user's estate planning documents requires and limits digital asset content disclosure to D (the user's named executor), the custodian must and may disclose that content only to D because the estate planning document disclosure instructions override the inconsistent terms-of-service agreement disclosure directions.

This digital asset distribution problem presents a significant practical problem for custodians. Estate planning document directions are not standard, and the instructions can come in any of several kinds of documents. Under Section 4, “the user (i.e., digital asset owner) may allow or prohibit in a will, trust, power of attorney, or other record, disclosure to a fiduciary of some or all of the digital asset owner's digital assets . . . .” And according to the related Uniform Law Commission's RUFADAA comments, a “fiduciary charged with managing the owner's digital assets must provide a copy of the relevant document to the custodian when requesting access . . . .” A custodian will not know immediately (or even promptly) after a digital asset owner's death whether any such document with disclosure directions exists and if so whether, for example, the document prohibits disclosure entirely or to anyone other than a named fiduciary, or whether the document allows or requires disclosure to a named fiduciary but does not prohibit additional disclosures.

### The RUFADAA “Safe Harbor” Solution

Under RUFADAA, the custodian can qualify for the highest disclosure priority tier (set forth above), thereby avoiding any such overriding estate planning document directions, by using the specified “online tool” procedures with a “designated recipient” (together, the “safe harbor”) as disclosed herein. For example, the custodian can establish a terms-of-service agreement providing for the digital asset owner's disclosure or distribution directions to a “designated recipient” in the online tool as disclosed herein with directions the digital asset owner may modify or delete at any time. Critical to the success of such an online tool and technologically-implemented procedure is understanding the RUFADAA defined terms, “online tool” and “designated recipient.”

### The RUFADAA “Designated Recipient” and “Online Tool”

Under RUFADAA, a “designated recipient” is not simply someone designated to receive information, and an “online tool” is not simply a tool for making online designations. Section 2(9) defines a “Designated recipient” as “a person chosen by a user using an online tool to administer digital assets of the user.” [Emphasis added] Section 2(17) defines a “Person” to include not just a natural person also a “legal entity.” Section 2(16) defines an “Online tool” as “an electronic service provided by a custodian that allows the user, in an agreement distinct from the terms-of-service agreement between the custodian and user, to provide directions for disclosure or nondisclosure of digital assets to a third person.” [Emphasis added] The Uniform Law Commission's Section 2 comments indicate the online tool direction recipient must be a “designated recipient” and that administering digital assets means managing them, stating in relevant part as follows: “An ‘online tool’ is a mechanism by which a user names a [person] to manage the user's digital assets after the occurrence of a future event, such as the user's death . . . [and] [t]he named [person] is referred to as the ‘designated recipient’ in the act . . . .” [Emphasis added] Section 6 requires that the designated recipient must at a minimum have specific assigned tasks, allowing the custodian to limit disclosure to that “sufficient to perform the tasks with which the . . . designated recipient is charged . . . .”

Consequently, in the example set forth above, the A, B, and C group of individuals the digital asset owner selected to receive a digital asset content disclosure does not include a “designated recipient”; because, no such individual will administer (manage) the digital assets in a manner the digital asset owner has directed (whether general management or an assigned task); instead, each individual will simply have access to the information. The digital asset owner's estate planning document disclosure or non-disclosure directions can override the digital asset owner's directions to directly disclose digital asset content to them (even if the digital asset owner did not intent that result).

Custodians should focus on designated recipients, while digital asset owners focus on those who will ultimately receive the digital asset content disclosures. Any reference in this patent application to a “designated recipient” is to that term as used in RUFADAA and therefore means a natural person or entity who administers digital assets and distributes digital asset content pursuant to a digital asset owner's online tool directions. Any reference in this patent application to an “ultimate recipient” is not a reference to a RUFADAA term, but refers to the person or entity (or people or entities) to whom or which the digital asset owner directs the designated recipient to distribute digital asset content pursuant to the online tool. These ultimate recipients may in turn share the information with others or use it, for example, for the digital asset owner's (i.e., user's) final arrangements.

Effectively, RUFADAA provides custodians with an essential safe harbor from the risk of distribution directions in potentially difficult-to-find estate planning documents, if the user designates a person or entity qualifying as a “designated recipient” to perform specific tasks with respect to the user's digital assets through an online tool that, under an agreement distinct from the terms-of-service agreement, allows the user to modify or delete such instructions at any time.

Custodians want the legal protection that comes with good faith RUFADAA compliance; they do not want to risk the potential liability exposure of improper private information disclosure. RUFADAA does not make custodians strictly liable for digital asset content distributions inconsistent with estate planning document directions, but focuses on whether the custodian acted in “good faith.” Therefore, well-advised custodians will proceed cautiously following a digital asset owner's (i.e., user's) death, unless they are confident they are disclosing the user's digital asset content to a “designated recipient” as directed in the requisite online tool. Absent confidence in that situation, for good faith RUFADAA compliance purposes, custodians will make reasonable efforts to determine whether estate planning documents with RUFADAA disclosure or non-disclosure directions exist. That process will take time and manual review of correspondence if not legal documents. For custodians attempting to comply with RUFADAA in good faith to achieve its protections, the process will render impractical immediate distributions of a deceased digital asset owner's digital asset content for final arrangements.

In various example embodiments described herein will ensure that the online tool instructions of a deceased digital asset owner (user) will override any contrary estate planning document directions. This will allow custodians to promptly distribute final arrangements digital asset information as the user directed, under a fully automated, instant and secure process that uses modern cryptography. As a result, custodians will receive legal protections for disclosure under RUFADAA. And after providing agreed-upon evidence of the user's death to the custodian, those to whom the user directed disclosure will promptly receive that information exactly as the user directed. However, the various example embodiments disclosed herein add the critical features of drawing on Internet information with AI to help (1) the user plan for final arrangements and (2) the person responsible for carrying out final arrangements can purchase the necessary final arrangements goods and/or services. It may also include providing that responsible person with automated final arrangements activities scheduling assistance. Additionally, it may include helping to ensure funding is available and proving the use of funds for authorized purposes.

### Various Example Embodiments Provide a RUFADAA Compliant On-Line Tool

The various example embodiments disclosed herein provide a system and method for ensuring that a custodian does not impermissibly disclose the digital asset content of a deceased digital asset owner, but makes disclosure as the digital asset owner directed. Furthermore, the various example embodiments disclosed herein provide a system and method that allows for digital asset content distribution in a manner that is secure through end-to-end data encryption, may be fully automated and eliminate manual document review (with its related delay and error potential), and is fully traceable to provide digital proof of performance. The example embodiments of the technologically-implemented system and method disclosed herein advantageously fill these needs and address deficiencies that would otherwise exist, by providing a system and process that allows custodians to know they are disclosing digital asset content to a RUFADAA “designated recipient” in a manner using modern cryptography and that overrides any inconsistent deceased digital asset owner estate planning document disclosure or non-disclosure directions.

The example embodiments disclosed herein are unique when compared with other known processes and solutions in that the disclosed embodiments will provide a way for a custodian to instantly verify with digital evidence returned from a third party (designated recipient) to whom the custodian distributed (or directed distribution of) digital asset content that the third party received that content, and if that third party was directed in the online tool to further distribute that content the third party did so as instructed (i.e., that the designated recipient received, took control of, and distributed the content as the user directed in an online tool with directions the user could modify or delete at any time). This process will show that the custodian has distributed digital asset content to a RUFADAA designated recipient. It will elevate the disclosure to the highest tier of RUFADAA's three-tier disclosure hierarchy such that the disclosure directions will override any inconsistent disclosure directions the user's estate planning documents may have contained. This will remove the practical digital asset timing constraints described above because custodians will know the directions under the online tool will override inconsistent estate planning document directions. The confirmed digital asset content “hand off” through data hashing and integrity checks will give custodians and/or data storage providers confidence they can delete or expunge data and clear storage earlier than without that evidence. Because the system and method disclosed herein may be fully automated, the disclosed embodiments can expedite the process of distributing digital asset content that may be required or helpful promptly after a digital asset owner's death for final arrangements. Additionally, the disclosed system and method is unique in that it will help users plan and potentially fund their final arrangements, and then later help those they have chosen to carry out final arrangements activities locate related goods and/or services in an efficient manner, and possibly schedule those activities and even pay for them and track payment. This process will improve the functioning and utility of the related computer system for custodians, data storage providers (when they store the data), users, and users' successors in interest. It will also improve the functioning and utility of the overall process of centralizing digital asset content for a time when it is needed after a user's death and then promptly distributing it as the user directed in a secure manner.

The system and method as disclosed herein are different and more efficient than other known processes or solutions. More specifically, it will require the distribution of final arrangements digital asset content to a RUFADAA designated recipient (rather than a third party without any duty to administer those digital assets), whether that third party carries out final arrangements activities itself or further distributes the digital asset content, as the user directed, to at least one ultimate recipient. The disclosed system and method, with the benefits of modern cryptography, will allow for a process of disclosing the information that overrides any inconsistent disclosure or nondisclosure instructions in a deceased user's estate planning documents. This will allow for immediate and fully automated digital asset content distributions upon the custodian's receipt of user death evidence under terms-of-service agreement protocols. Because the custodian will know the online tool directions will override any inconsistent estate planning document directions, the custodian will know that in disclosing user information as directed in the online tool the custodian is releasing private information with RUFADAA-compliant legal protections. The custodian can take advantage of a fully-automated and instant process that will allow those storing the digital asset data to better manage the data and promptly delete or expunge the data and save storage space (having proof of digital transmissions or distributions). The system and process can be fully automated and secure with end-to-end encryption. Digital asset owners (users) will know they can direct the prompt disclosure and distribution of digital asset information, such that the information or digital assets can be used for final arrangements. The disclosed system and method is also unique in that it will help users plan and potentially fund their final arrangements and then later help those they have chosen to carry out final arrangements activities locate related goods and/or services in an efficient manner, and possibly schedule those activities and even pay for them and track payment. There currently is no formal structure for collecting and distributing final arrangements information in this manner.

The practical technological solution disclosed in the various example embodiments herein provides a solution to an industry problem that is very unconventional. Estate planners have no control over terms-of-service agreements or online tools. They focus on drafting estate planning document disclosure directions. Data storage providers and custodians storing data profit primarily from serving live customers. They want to comply with disclosure laws but have little incentive to invent creative solutions to help users plan their final arrangements or to later help deceased users' successors carry out final arrangements activities. Software engineers focus on software development. They are not RUFADAA experts (to the extent they even know about RUFADAA) and look for the most efficient (usually direct) way to ensure secure data distribution. Database searches with AI, digital asset content distribution following a user's death, scheduling activities, and paying for and tracking the payment of final arrangements is a multi-disciplinary effort involving disciplines with very different focuses and participants with large information gaps due to the information silos in which they work. An example embodiment using modern cryptography in this manner would not be obvious to any of them and is very unconventional in the context of digital asset content disclosure. The solution disclosed in the various example embodiments herein enhances the operation and utility of a system of computers, an array of data storage devices, and a data network used to distribute digital asset content. For that reason, the example embodiments disclosed herein enhance the operation and utility of the entire technical field of centralizing digital asset owners' digital asset content for ultimate distribution after digital asset owner deaths.

The user through the online tool can direct the designated recipient to in turn distribute final arrangements digital assets content to an ultimate recipient or ultimate recipients who will carry out the tasks of procuring final arrangements goods and/or services along with scheduling final arrangements activities. As indicated above, RUFADAA Section 2(9) defines a “designated recipient” as “a person chosen by a user using an online tool to administer digital assets of the user” [emphasis added] The Uniform Law Commission comments to RUFADAA Section 2 states in relevant part as follows:
An “online tool” is a mechanism by which a user names an individual to manage the user's digital assets after the occurrence of a future event, such as the user's death or incapacity. The named individual is referred to as the “designated recipient” in the act to differentiate the person from a fiduciary. A designated recipient may perform many of the same tasks as a fiduciary, but is not held to the same legal standard of conduct. [Emphasis added]

The reference to singular person or individual and multiple digital assets suggests that with respect to any given custodian the designated recipient may chose only one person (which, under the RUFADAA Section 2 definition of “person,” may be a natural person or an entity) to administer all digital assets the content of which the custodian is disclosing as directed. Even assuming there may be only one designated recipient, nothing in RUFADAA suggests that the designated recipient as part of the administrative function needs to personally carry out every administrative act without the ability to further distribute digital asset content to an ultimate recipient who carries out directed tasks. Any conclusion to the contrary would add RUFADAA text by implication and could produce an impractical situation because a single person or entity might not be in a position to personally handle every function relating to digital assets. For example, the user could direct the designated recipient to further distribute digital asset content required for estate administration to ultimate recipient A and digital asset content required for final arrangements to ultimate recipient B. In that situation, the person directed to allocate digital asset content to ultimate recipients A and B would take control of and manage digital asset content as the user directed in the online tool. That activity would be consistent with the above-referenced RUFADAA Section 2 comments indicating that a person the user directs in an online tool “to manage the user's digital assets after the occurrence of a future event, such as the user's death . . . .” The person or entity making the digital asset content disclosures to these ultimate recipients pursuant to the necessary online tool would be a “designated recipient” and thus digital asset content distribution in this manner would be in the desired top RUFADAA tier. In this type of situation, in which an ultimate recipient rather than the designated recipient carries out the final arrangements, that person would not only receive the user's final arrangements digital asset content and necessary decryption keys but also would have access to the software license or licenses necessary for efficient final arrangements goods and/or services procurement (and potentially scheduling and paying for the goods and/or services).

It would be desirable to have a process for ensuring that a custodian does not impermissibly disclose the final arrangements digital asset content of a deceased user but makes disclosure as the user directed, after proper notice of user death, promptly enough that the information can be used for final arrangements that may take place shortly after death. These final arrangements could, for example, involve burial or other disposition; a memorial that may include photographs, song lists and messages to family and friends; and information necessary for death certificate information. Furthermore, it would be desirable to have a process that allows for digital asset content distribution in a manner that is secure through end-to-end encryption, may be fully automated and eliminate manual document review (with its related delay and error potential), and is fully traceable to provide digital proof of performance. And it would be desirable to have a technology-driven process that both helps users plan, budget for and even pre-fund final arrangements while also ultimately helping those carrying out final arrangements procure the necessary goods and/or services and schedule activities.

The disclosed system and method will advantageously fill these needs and address deficiencies that would otherwise exist. It will provide a process that allows custodians to know they are disclosing final arrangements digital asset content to a RUFADAA “designated recipient” in a manner using modern cryptography and that overrides any inconsistent deceased user estate planning document disclosure or non-disclosure directions. And it will help users and those tasked with carrying out their final arrangements deal with those activities in an efficient manner, using available computer systems and databases along with AI applications.

Disclosed is a system and method of that may consist of the following steps: With the assistance of AI the user extracts Internet information (e.g., through web scraping) to help plan final arrangements and determine the availability and cost of final arrangements goods and/or services at that time. The user transfers digital asset content including (but not necessarily limited to) final arrangements planning to the custodian. This transfer process can occur in any number of ways, from manual input to AI applications. In accordance with a terms-of-service agreement between the user and custodian, through the use of an online tool with directions the user may modify or delete at any time, the user directs the custodian to disclose, following report of the user's death, the digital asset content to a third party who must administer the digital asset content as the user directed. That digital asset content includes final arrangements information and possibly other information. When a person designated in the terms of service agreement between the user and custodian reports the user's death under protocols set in the terms-of-service agreement, the custodian segregates digital asset content to the extent directed in the online tool and distributes all of the digital asset content with a decryption key or keys (if data is segregated) to the designated recipient. The custodian provides the reporting person with integrity check evidence of the digital asset content transfer to the designated recipient. The designated recipient provides the custodian with an integrity check proving the transfer and receipt of the digital asset content and encryption key or keys.

In one embodiment, the designated recipient allocates and then distributes allocated final arrangements digital asset content and a decryption key for the particular distributed information to at least one individual ultimate recipient. Each ultimate recipient provides integrity checks to the designated recipient receipt, which provides that integrity check evidence to the custodian to prove these distributions and digital asset administration by the designated recipient.

In another embodiment, the designated recipient does not further distribute the final arrangements digital asset content to a third party for administration of those digital assets but administers them by carrying out final arrangements activities. That designated recipient retains and uses the decryption key and provides integrity check evidence to the custodian to prove these distributions to the designated recipient.

In various example embodiments, the custodian can promptly and automatically distribute digital asset content in the top RUFADAA tier, and the individual or entity responsible for final arrangements will have access to licensed software (e.g., as seen with tax software that includes taxpayer carryforward information) with which it will use this distributed final arrangements digital asset content and with the assistance of AI will extract Internet information (e.g., through web scraping) to determine the availability and cost of final arrangements goods and/or services.

The disclosed example embodiments may include various optional features, including without limitation the following features:
1. Scheduling. The individual or entity responsible for final arrangements may also combine distributed final arrangements digital asset content with information regarding the availability of goods and/or services, and even other manually-input information (such as religious, eulogist or other services participant availability or fight or other transportation information relating to them) and use scheduling software to propose a final arrangements event schedule that can be used or with the assistance of that computer refined into a final schedule.
2. Funding and tracking. As indicated above, RUFADAA involves the distribution of information (in this context, digital asset content) rather than the transfer of title to cash or other property. To pre-fund some or all final arrangements costs, the user or another must set aside funds a person can use for those costs. In most instances, this can be accomplished through a joint account, a pay-on-death account, or a trust account under the control of a co-trustee or successor trustee. A third party (e.g., the user's parent) can also fund such an account. Through the online tool the user can name a primary designated recipient to carry out final arrangements and a backup or backup designated recipient for that purpose. The person with custody of funds to pay final arrangements costs need not be the designated recipient, but having that person be the designated recipient can result in a more efficient process of procuring and paying for final arrangements goods and/or services. In most instances, the user can achieve that result through account beneficiary designations or use of a trust account as described above. Payments from the account can be tracked and reflected in an accounting (which will occur largely with AI assistance over time) to provide trust or estate beneficiaries with an accounting regarding funds use. That process can use modern cryptography to varying degrees. It can be an be largely or entirely automated and can be secure.
3. Updates. Information can become stale over time. Software using AI and Internet data extraction techniques can provide relevant update information. This could include, for example, changes in available goods and/or services availability or cost. The user could also input relevant information changes, such as a change in residence that impacts the cost or availability of final arrangements goods and/or services. If the user has created an account to pre-fund costs, the update can compare projected costs with available funds and send an alert if there is a shortfall or even trigger an automatic funds transfer to the final arrangements account from another account.
4. Digital asset content storage. Because a custodian need not store digital asset content, but under RUFADAA Section 2(8) definition of a “custodian” also includes “a person that carries, maintains, processes, [or] receives” digital asset content, the present method may also include distribution of digital asset content a data storage service rather than content the custodian stores. Following the user's death and the distribution of digital asset content, the user may also direct that a copy of that information to be stored with a third party who will hold it for a reasonable time in a “digital asset cemetery” where it would be available in the event required by subpoena or court order (e.g., for litigation) and ultimately deleted.

In various example embodiments described herein, the digital asset distribution system provides a series of computer-implemented processes to assist in the distribution or transfer of digital assets upon the death of the digital asset owner. Details of the various example embodiments are described in more detail below.

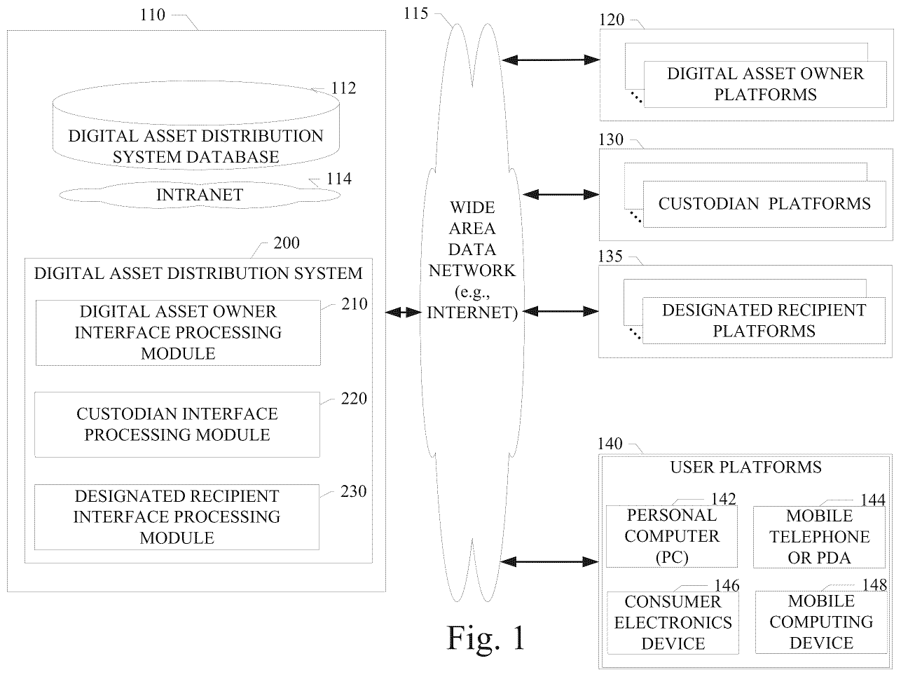

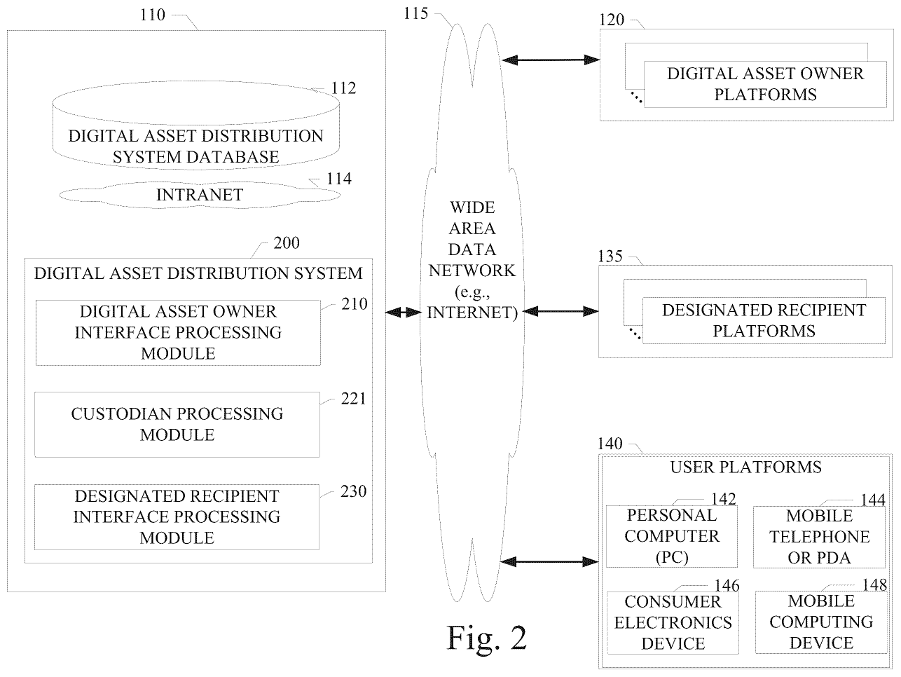

FIG. 1, in an example embodiment, illustrates a system and method for planning final arrangements with digital asset content distribution in a RUFADAA-compliant manner. In various example embodiments, an application or service, typically provided by or operating on a host site (e.g., a website) 110, is provided to simplify and facilitate the downloading or hosted use of the digital asset distribution system 200 of an example embodiment. Typically, the digital asset distribution system 200 can be hosted by the host site 110 for a networked user at a user platform 140. In the example embodiments disclosed herein, the digital asset distribution system 200 can correspond to the “on-line” tool defined by RUFADAA. The digital asset distribution system 200 can be managed directly by a custodian (e.g., see the example embodiment shown in FIG. 2), or the digital asset distribution system 200 can be managed on behalf of the custodian by a third-party service provider. The details of the digital asset distribution system 200 for an example embodiment are provided below.

Referring again to FIG. 1, the digital asset distribution system 200 can be in network communication with a plurality of digital asset owner platforms 120, custodian platforms 130, and designated recipient platforms 135. Each of these computing platforms can be configured like user platforms 140. The digital asset owner platforms 120 can include user platform computing and/or communication devices, websites, or other network resources at which a digital asset owner (or someone legally empowered to act on behalf of the digital asset owner) can interact with the digital asset distribution system 200, corresponding to the “on-line” tool defined by RUFADAA. The custodian platforms 130 and designated recipient platforms 135 can include user platform computing and/or communication devices, websites, or other network resources at which custodians and designated recipients can interact with the digital asset distribution system 200 as described in more detail below. The digital asset distribution system 200 can be configured to provide data communications (including encrypted data communications) for the user platforms serving as RUFADAA-compliant networked platforms for digital asset owners to empower custodians and designated recipients to distribute digital asset content to individual ultimate recipients in a digital or computer-readable form via the network 115. Additional users of the network ecosystem shown in FIG. 1 operating computing platforms such as user platforms 140 can include the individual ultimate recipients of the digital assets of a deceased digital asset owner as described in more detail below.

The digital asset distribution system 200 may also be configured to provide data communications for the digital asset owner platforms 120 to enable the networked usage, transfer, or downloading of a digital asset owner interface processing module 210. The digital asset owner interface processing module 210 may reside on a digital asset owner platform 120 or may be downloaded to or from the host site 110. In other words, the digital asset owner interface processing module 210 may be used, transferred, or downloaded from/to the host site 110 and the digital asset distribution system 200 therein via the network 115. As such, the digital asset owner interface processing module 210 may be hosted by the host site 110 or locally resident and locally used by a digital asset owner platform 120. Similarly, the digital asset distribution system 200 may also be configured to provide data communications for the custodian platforms 130 to enable the networked usage, transfer, or downloading of a custodian interface processing module 220. The custodian interface processing module 220 may reside on a custodian platform 130 or may be downloaded to or from the host site 110. In other words, the custodian interface processing module 220 may be used, transferred, or downloaded from/to the host site 110 and the digital asset distribution system 200 therein via the network 115. As such, the custodian interface processing module 220 may be hosted by the host site 110 or locally resident and locally used by a custodian platform 130. Moreover, the digital asset distribution system 200 may also be configured to provide data communications for the designated recipient platforms 135 to enable the networked usage, transfer, or downloading of a designated recipient interface processing module 230. The designated recipient interface processing module 230 may reside on a designated recipient platforms 135 or may be downloaded to or from the host site 110. In other words, the designated recipient interface processing module 230 may be used, transferred, or downloaded from/to the host site 110 and the digital asset distribution system 200 therein via the network 115. As such, the designated recipient interface processing module 230 may be hosted by the host site 110 or locally resident and locally used by a designated recipient platform 135.

One or more of the digital asset owner platforms 120, the custodian platforms 130, and the designated recipient platforms 135 can be provided by one or more third party providers operating at various locations in the network ecosystem. It will be apparent to those of ordinary skill in the art that digital asset owner platforms 120, the custodian platforms 130, and the designated recipient platforms 135 can include or be any of a variety of networked third party information providers/consumers or on-line service providers/consumers as described in more detail below. In a particular embodiment, a resource list maintained at the host site 110 can be used as a summary or list of all digital asset owner platforms 120, custodian platforms 130, and designated recipient platforms 135, which users or the host site 110 may visit/access and from which users or the host site 110 can obtain or store digital asset content or related information. The host site 110, digital asset owner platforms 120, custodian platforms 130, designated recipient platforms 135, and user platforms 140 may communicate and transfer data and information in the data network ecosystem shown in FIG. 1 via a wide area data network (e.g., the Internet) 115. Various components of the host site 110 can also communicate internally via a conventional intranet or local area network (LAN) 114.

Networks 115 and 114 are configured to couple one computing device with another computing device. Networks 115 and 114 may be enabled to employ any form of computer readable media for communicating information from one electronic device to another. Network 115 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth™, satellite, or modem and temporary telephone link.

Networks 115 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 115 and 114 may also include an autonomous system of terminals, gateways, routers, and the like connected by wireless radio links or wireless transceivers. These connectors may be configured to move freely and randomly and organize themselves arbitrarily, such that the topology of networks 115 and 114 may change rapidly and arbitrarily.

Networks 115 and 114 may further employ a plurality of access technologies including 2nd (2G), 2.5, 3rd (3G), 4th (4G), 5th (5G) generation radio access for cellular systems, WLAN, Wireless Router (WR) mesh, and the like. Access technologies such as 2G, 3G, 4G, 5G, and future access networks may enable wide area coverage for mobile devices, such as one or more of client devices 141, with various degrees of mobility. For example, networks 115 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 115 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 115 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The digital asset owner platforms 120, custodian platforms 130, and/or the designated recipient platforms 135 may include any of a variety of providers or consumers of network transportable digital data. The network transportable digital data can be transported in any of a family of file formats and associated mechanisms to enable a host site 110 and a user platform 140 to send/receive digital asset data or related data to/from a digital asset owner platform 120, a custodian platform 130, and/or designated recipient platforms 135 over the network 115. In example embodiments, the file format can a text format, graphic format, image format, video format, audio format, or any related conventional data format. Other file formats and data transport protocols may be used. For example, data formats such as Microsoft™ Access Database Format (MDB), Portable Document Format (PDF), audio (e.g., Motion Picture Experts Group Audio Layer 3-MP3, and the like), video (e.g., MP4, and the like), and any proprietary interchange format defined by specific sites can be supported by the various embodiments described herein. Moreover, a digital asset owner platform 120, a custodian platform 130, and/or a designated recipient platforms 135 may provide or support a variety of different data sets, computational modules, applications, or the like.

In a particular embodiment, a user platform 140 with one or more client devices enables a user to access data provided by the digital asset distribution system 200 via the host 110 and network 115. Client devices of user platform 140 may include virtually any computing device that is configured to send and receive information over a network, such as network 115. Such client devices may include portable devices 144, such as, cellular telephones, smart phones, camera phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. The client devices may also include other computing devices, such as personal computers 142, multiprocessor systems, microprocessor-based or programmable consumer electronics, network PC's, and the like. The client devices may also include other processing devices, such as consumer electronic (CE) devices 146 and/or mobile computing devices 148, which are known to those of ordinary skill in the art. As such, the client devices of user platform 140 may range widely in terms of capabilities and features. Moreover, a web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript™, EXtensible HTML (xHTML), Compact HTML (CHTML), and the like, to display and/or send digital information. In other embodiments, mobile devices can be configured with applications (apps) with which the functionality described herein can be implemented.

The client devices of user platform 140 may also include at least one client application that is configured to receive digital asset content and/or control data from another computing device via a wired or wireless network transmission. The client application may include a capability to provide and receive textual data, graphical data, video data, audio data, and the like. Moreover, client devices of user platform 140 may be further configured to communicate and/or receive a message, such as through a Short Message Service (SMS), direct messaging (e.g., Twitter™), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Referring again to FIG. 1, the digital asset distribution system 200 for an example embodiment is shown to include a digital asset distribution system database 112. The digital asset distribution system database 112 can be used to retain a variety of information data sets including, but not limited to, digital asset owner information, digital asset content or related information, custodian data, designated recipient data, digital asset distribution analytics, and the like. It will be apparent to those of ordinary skill in the art that the digital asset distribution system database 112 can be locally resident at the host site 110 or remotely located at other server locations or stored in network cloud storage.

Referring again to FIG. 1, host site 110 of an example embodiment is shown to include the digital asset distribution system 200. In an example embodiment, digital asset distribution system 200 can include a digital asset owner interface processing module 210, a custodian interface processing module 220, and a designated recipient interface processing module 230. Each of these modules can be implemented as software components executing within an executable environment of digital asset distribution system 200 operating on host site 110 or user platform 140. Each of these modules of an example embodiment is described in more detail below in connection with the figures provided herein.

Referring still to FIG. 1, the digital asset distribution system 200 can include a digital asset owner interface processing module 210, a custodian interface processing module 220, and a designated recipient interface processing module 230. The digital asset owner interface processing module 210 can facilitate communication and the transfer of data, digital assets, and documents between a user at a digital asset owner platform 120 and the host site 110. The custodian interface processing module 220 can facilitate communication and the transfer of data, digital assets, and documents between a user at a custodian platform 130 and the host site 110. The designated recipient interface processing module 230 can facilitate communication and the transfer of data, digital assets, and documents between a user at a designated recipient 135 and the host site 110. The digital asset owner interface processing module 210, custodian interface processing module 220, and designated recipient interface processing module 230 can be configured to perform the processing as described in more detail below. The digital asset owner interface processing module 210 can be resident at the host site 110, resident on a digital asset owner platform 120, or partially resident on a plurality of user platforms 140. Similarly, the custodian interface processing module 220 can be resident at the host site 110, resident on a custodian platform 130, or partially resident on a plurality of user platforms 140. Moreover, the designated recipient interface processing module 230 can be resident at the host site 110, resident on a designated recipient platform 135, or partially resident on a plurality of user platforms 140. The digital asset distribution system 200 be configured to provide data communications for the digital asset owner platforms 120, the custodian platforms 130, and the designated recipient platforms 135 to enable the networked usage, distribution, disclosure, transfer, or downloading of digital assets, information, requests, images, documents, and related data to facilitate the authorized distribution of an owner's digital assets. The components and processes for the authorized distribution of an owner's digital assets as embodied in the digital asset owner interface processing module 210, the custodian interface processing module 220, and the designated recipient interface processing module 230 are described in more detail below.

An example embodiment provides a system and method that allows a digital asset owner at a digital asset owner platform 120 to securely transfer digital asset content, related data, and documents between their computer or computer systems and the host site 110, which can be a third-party's cloud-based computing cluster. This secure data transfer capability can be implemented and controlled by the digital asset owner interface processing module 210. This secure data transfer capability enables the digital asset owner or custodian to share specific digital asset content of the owner with approved designated recipients. This data transfer may take place via the data network 115 using protocols such as HTTP, FTP, SMTP, etc., whereby information, that may be encrypted using SSL/TLS, is exchanged in a variety of formats (including, but not limited to, XML and JSON formats). The digital asset owner or custodian can share the digital asset content via the host site 110.

Referring now to FIG. 2, an example embodiment provides a system and method wherein the digital asset distribution system 200 can be managed directly by a custodian at the host site 110. In this configuration, the custodian processing module 221 manages the interactions between the digital asset owner platforms 120, the designated recipient platforms 135, and the individual ultimate recipients of the digital assets operating user platforms 140. In other respects, the alternative example embodiment shown in FIG. 2 operates in a manner similar to the embodiment shown in FIG. 1 and described in more detail below.

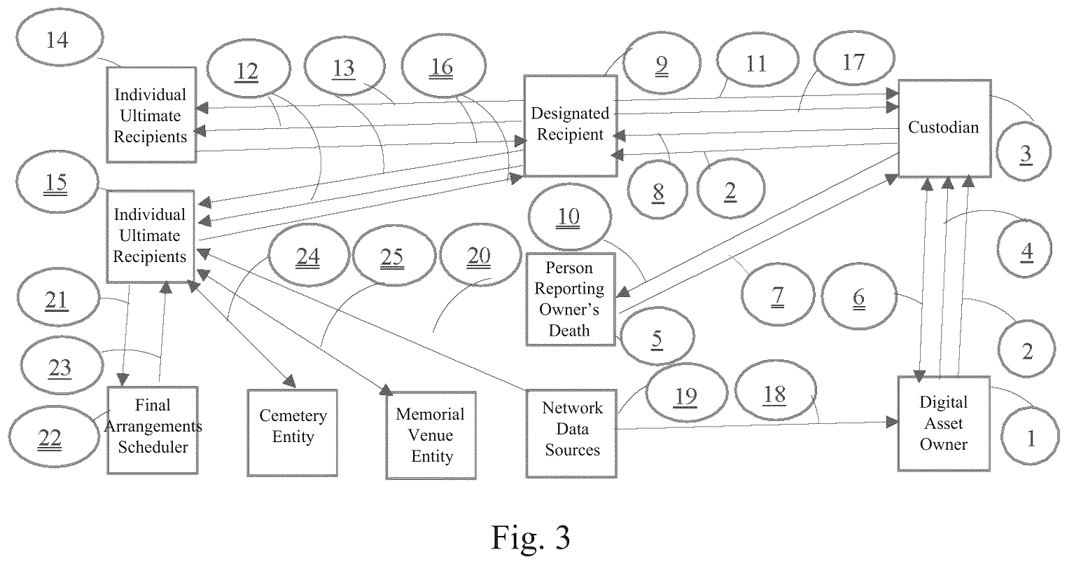

Referring now to FIG. 3, an example embodiment provides a system and method that allows digital asset owners to use the digital asset owner interface processing module 210 via a digital asset owner platform 120 to initiate a process whereby the digital assets of the owner can be arranged, configured, and authorized for RUFADAA-compliant distribution after the death of the digital asset owner. Referring again to FIG. 3, the schematic shows an information or data processing flow for an example embodiment, in which a custodian 3 at a custodian platform 130 using custodian interface processing module 220 (or alternatively using custodian processing module 221) may store or otherwise assume control of the distribution of the digital asset content of a digital asset owner 1, the digital asset content being distributed to a designated recipient with instructions to allocate content to ultimate recipients, and in which scheduling software is used but optional payment tracking features are not involved. In operation 2 shown in FIG. 3, the digital asset owner 1 using the digital asset owner interface processing module 210 at a digital asset owner platform 120 can transfer digital asset content that may include final arrangements planning done with software including AI and standard Internet data extraction applications (or digital asset content access data) and distribution instructions or otherwise provide access to the digital asset content to/for the custodian 3, after authenticating the identity of the custodian 3. The digital asset owner 1 at operation 4 can further provide authenticated or authenticating credentials or other information empowering the custodian 3 to act on behalf of the digital asset owner 1 with regard to the disclosure or distribution of the owner's 1 digital assets upon the death of the digital asset owner 1. In operation 6 shown in FIG. 3, the digital asset owner 1 can further provide an authenticated agreement (e.g., a terms-of-service agreement) or other authenticated information to the custodian 3 advising the custodian 3 of the name(s) or other identifying information, which identifies the designated recipient(s) 9 to whom/which the custodian 3 will provide the disclosure or distribution of the owner's 1 digital assets upon the death of the digital asset owner 1. The authenticated agreement (e.g., a terms-of-service agreement) or other authenticated information provided to the custodian 3 by the digital asset owner 1 in operation 6 can also inform the custodian 3 of the name(s) or other identifying information, which identifies a death reporting individual or entity 5 who/which has the authority to report the death or incapacity of the digital asset owner 1 under protocols specified in the authenticated agreement. The custodian 3 can send an acknowledgement back to the digital asset owner 1 to indicate receipt of the digital asset content, distribution instructions, and authenticated agreement.

In operation 7 shown in FIG. 3, an individual or entity 5 who/which has the authority to report the death or incapacity of the digital asset owner 1 reports the death or incapacity of the digital asset owner 1 to the custodian 3. Upon receipt of the authenticated death or incapacity notice, the custodian 3 can segregate or assemble the owner's 1 digital asset content as directed by the digital asset owner 1. In operation 8 shown in FIG. 3, the custodian 3 can then distribute or disclose the owner's 1 designated digital asset content as directed by the digital asset owner 1 with a decryption key or keys to the designated recipient(s) 9. In operation 10 shown in FIG. 3, after the custodian 3 distributes or discloses the owner's 1 digital asset content to the designated recipient(s) 9, the custodian 3 can provide to the individual or entity 5 who/which has the authority to report the death or incapacity of the digital asset owner 1 information indicative of integrity check evidence that verifies that the digital asset content was transferred to the designated recipient(s) 9. Similarly, at operation 11 shown in FIG. 3, the designated recipient(s) 9 can provide the custodian 3 with a first integrity check or authenticated receipt proving and verifying the transfer and receipt of the digital asset content and decryption key by the designated recipient(s) 9. In operations 12 and 13 shown in FIG. 3 and in response to receipt of the digital asset content and decryption key, the designated recipient 9 can allocate and then distribute the allocated owner's 1 digital asset content and a corresponding decryption key(s) for the particular distributed digital asset content to individual ultimate recipients 14 and 15. In operation 16 shown in FIG. 3 and in response to receipt of the digital asset content and decryption key(s), the individual ultimate recipients 14 and 15 can provide second integrity checks or receipts to the designated recipient(s) 9, which provides integrity check evidence to prove these distributions of the digital assets by the designated recipient(s) 9 to the individual ultimate recipients 14 and 15. Subsequently, in operation 17, the designated recipient(s) 9 can provide the second integrity check evidence to the custodian 3 to prove the distribution of the digital assets by the designated recipient(s) 9 to the individual ultimate recipients 14 and 15. The user receives the digital assets or related information 18 from networked data sources 19 regarding final arrangements and includes that information as part of the digital asset content 2 transferred to the custodian 3. That information is distributed to the designated recipient 9 (along with any other digital asset information) after the user's reported death, and in this instance final arrangements digital assets information is further distributed to one of the ultimate recipients 15 and the rest of the digital asset information is distributed to the other ultimate recipient 14. The ultimate recipient responsible for final arrangements 15 draws on then-current information 20 from the Internet or other networked data source 19, sends that network information 20 combined with final arrangements digital asset information 12 and potentially other relevant information (such as participant availability) as final arrangements information 21 in interacting with a computer 22 that uses scheduling software to propose a final arrangements event schedule 23 that can be used or with the assistance of that computer refined into a final schedule. That ultimate recipient 15 then exchanges necessary information with a cemetery entity 24 and memorial venue entity 25 and, in practice, other people or entities involved in the final arrangements process.

Given the received integrity checks and/or receipts from the parties in the transactions described above, data storage providers, custodians, and designated recipients who stored digital assets or related information may delete or expunge the deceased digital asset owners' data as soon as reasonably possible to free up data storage space.

Reference is made to the background of the example embodiments as discussed above, including the discussion of the basic implementation of an example embodiment and some possible optional features. In a more complete version, the disclosed system and method comprises a custodian's processing of digital asset content the custodian does not store. As noted above, a RUFADAA custodian need not store data. In an alternative example embodiment, the RUFADAA custodian does not need to store the digital assets of the digital asset owner. A RUFADAA “custodian” must have or provide an account (including a terms-of-service agreement) with or for a digital asset owner; but, according to Section 2(8), the defined “custodian” need not store digital asset content. A custodian includes one who “carries, maintains, processes, receives, or stores a digital asset of a user.” Due to data storage cost and security concerns, some custodians may want existing storage providers (generally large companies with a broad range of services) to store digital assets and related data for a digital asset owner. One solution is for data storage providers to provide digital asset owners with a view (e.g., a portal) into the library of a digital asset owners' digital assets. To ensure privacy and a high degree of security, that digital asset data can be encrypted and then decrypted on demand for the digital asset owner (and ultimately those the digital asset owner wants to see the digital asset content after the digital asset owner's death) through that view.

A custodian may hold (or process as described above) a single type of final arrangements digital asset, such as photos for a memorial. Or the custodian may hold or process several kinds of final arrangements digital assets. This could include, for example, photos, song lists, and other information for a memorial; information required for death certificate preparation or an obituary; instructions regarding final arrangements, and messages to friends and family. That information will be distributed to the designated recipient to carry out final arrangements activities or to further distribution of the information to at least one ultimate recipient for that purpose. Any person or entity carrying out final arrangements activities will receive necessary decryption keys. Hashing the data can show all data deliveries and even track data. It can show not only that the custodian distributed the designed recipient data the custodian received from the user, but that the designated recipient in turn distributed the data as directed if the user directed such a distribution. This can be shown with hashing and integrity checks. A more complicated approach to proving final arrangements content distributions, such as blockchain, can be used but generally will not be required.

Modern cryptography with integrity checks can allow a custodian to prove that it distributed all final arrangements digital asset content it held, exactly as the user instructed in the online tool. This process becomes more complicated, but is still feasible if the custodian does not store the data, and still more complicated but still feasible if there are multiple kinds of final arrangements digital asset content relating to activities more than one person carries out.

A custodian that does not store but processes digital asset content can provide the data storage provider with a concatenation layer, or a concatenation artificial intelligence application programming interface (API), the data storage provider codes. On a digital asset owner's death, the data for all of the digital asset owner's digital assets can be concatenated (combined sequentially) into a single stream, with pre-specified dividers indicating the portions the digital asset owner wants the designated recipient to send to different ultimate recipients along with an integrity check (hash index) the custodian can use to verify that the custodian received accurately the data the service provider sent. The custodian receives the stream and the integrity check from the data storage provider, stores the content, and computes an integrity check of the content to verify it is the same as the integrity check the data service provider sent the custodian. This confirms that the custodian received accurately what the data service provider sent (if there is an inaccuracy the data stream can be retransmitted and corrected). The custodian then divides the content, computes integrity checks of the pieces, and sends the pieces and the integrity checks to the designated recipient for distribution to the ultimate recipients as the digital asset owner directed using the online tool disclosed herein. The ultimate recipients return the integrity checks that confirm they received accurately what the custodian sent to the designated recipient and the designated recipient in turn sent to the ultimate recipients. In another example embodiment, the designated recipient may perform some of the above-referenced steps of the custodian.

Data storage providers and custodians who store data want to delete or expunge deceased digital asset owners' data as soon as reasonably possible to free up storage space, but want to have proof that they made an appropriate and authorized digital asset content handoff. For example, if such a digital asset owner's data is sought by subpoena or court order, data storage providers and custodians can prove they distributed the data they had and can prove the identity of the ultimate recipient(s) of that data. An example embodiment also allows for the use of a place to store data for a reasonable time for such orders or subpoenas in a sort of “digital asset cemetery”. The missing piece the custodian or data storage provider needs in order to delete or expunge a digital asset is a demonstration that everything the custodian distributed to the designated recipient, which was then distributed to the ultimate recipient(s), equals in the aggregate what the custodian received from the data storage provider. Homomorphic hashing, a cryptographic technique, can provide this missing piece. Under homomorphic hashing, the integrity check of what the custodian received from the data storage provider can be determined easily from the integrity checks of what the designated recipient sent out to the ultimate recipient(s) as the user directed in an online tool. In this manner, it can be demonstrated with a very high degree of confidence that the custodian sent out everything the custodian received from the data storage provider, and to the correct ultimate recipient(s). Homomorphic hashing allows for the manipulation of data without actual access to the data and therefore allows the process described above to work with end-to-end encryption. This process shows that the ultimate recipients received accurately what the data service provider sent, all with the security of modern cryptography (including without limitation integrity and authenticity checks and with other standard data confirmation processes data storage providers can show they transferred correctly to the custodian all data they received from the right digital asset owner). Those who stored a deceased digital asset owner's data can more confidently delete or expunge the data with the knowledge that they have accurately delivered the data as directed. They can delete or expunge large data files and retain very small integrity check files of approximately the same length for each digital asset owner.

In terms of information flow, the digital asset owner provides the digital asset information to the custodian, who may store the digital asset information in the network cloud. When the custodian receives notice of the digital asset owner's death as per the terms of a service agreement (whether the digital asset owner is actually deceased), the custodian distributes the digital asset content to the designated recipient (which can be an entity related to the custodian or not, because RUFADAA simply refers to a designated recipient as a third person who administers the digital assets). The designated recipient in turn distributes the digital asset content as directed in the online tool as disclosed herein. This all happens instantly and securely with encryption and conditional instructions. The information distribution can be tracked with modern cryptography. Using the system and method disclosed herein, the designated recipient takes control of the digital asset content and under any reasonable definition administers and distributes the digital assets as required for “designated recipient” status, thereby enabling digital asset distribution according to the top RUFADAA tier and overriding any estate planning document instructions that might exist.

Another example embodiment can include the management of “shallow” digital asset information and more sensitive information. For example, the digital asset owner can provide the custodian with actions or information necessary to promptly obtain a death certificate (so the family does not have to search files at a stressful time) and a memorial (e.g., pictures, song lists, messages, disposition directions, etc.). It would not take much evidence of digital asset owner death to break that information loose. For digital asset information that is more sensitive or valuable, more proof would be required (e.g., a death certificate or some other reliable evidence, or death certification information in a digital form). This two-tiered or multi-tiered approach can be similarly implemented using the computer-implemented processes described above.

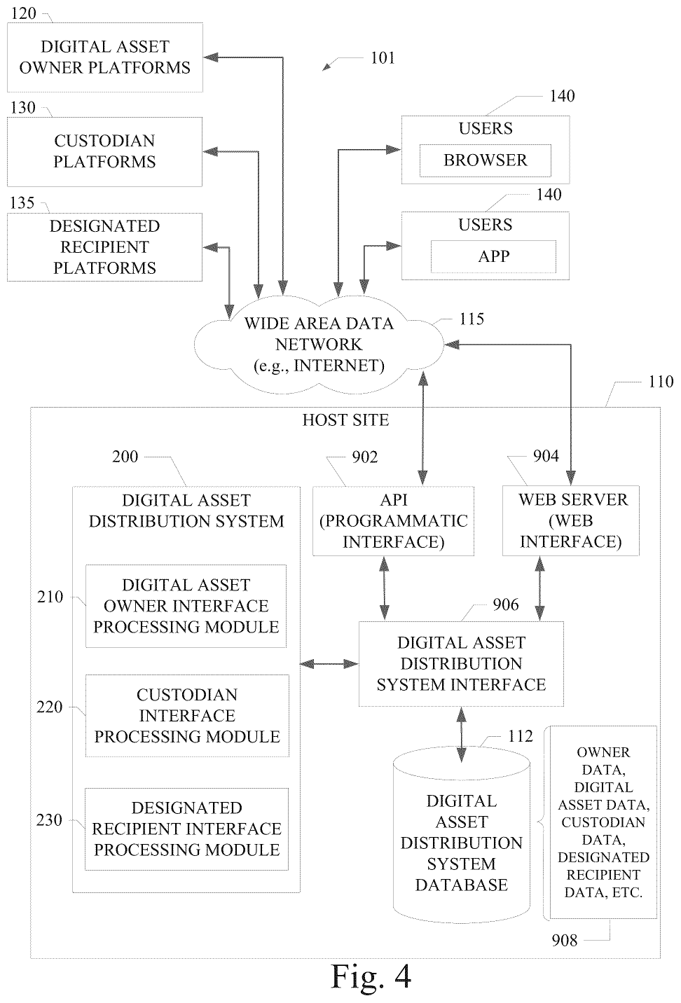

Referring now to FIG. 4, another example embodiment 101 of a networked system in which various embodiments may operate is illustrated. In the embodiment illustrated, the host site 110 is shown to include the digital asset distribution system 200. The digital asset distribution system 200 is shown to include the digital asset owner interface processing module 210, the custodian interface processing module 220, and the designated recipient interface processing module 230 as described above. In a particular embodiment, the host site 110 may also include a web server 904, having a web interface with which users may interact with the host site 110 via a user interface or web interface. The host site 110 may also include an application programming interface (API) 902 with which the host site 110 may interact with other network entities on a programmatic or automated data transfer level. The API 902 and web interface 904 may be configured to interact with the digital asset distribution system 200 either directly or via an interface 906. The digital asset distribution system 200 may be configured to access a data storage device 112 either directly or via the interface 906.

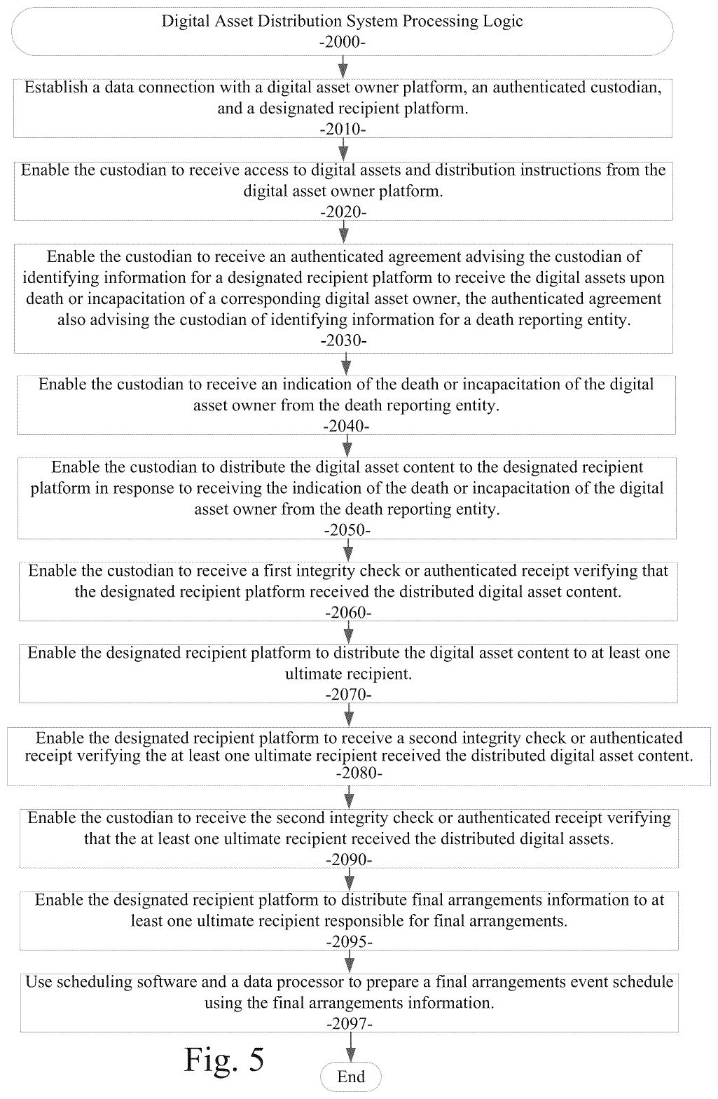

Referring now to FIG. 5, a processing flow diagram illustrates an example embodiment of a method implemented by the digital asset distribution system 200 as described herein. The method 2000 of an example embodiment can be configured to: establish a data connection with a digital asset owner platform, an authenticated custodian, and a designated recipient platform (processing block 2010); enable the custodian to receive access to digital assets and distribution instructions from the digital asset owner platform (processing block 2020); enable the custodian to receive an authenticated agreement advising the custodian of identifying information for a designated recipient platform to receive the digital assets upon death or incapacitation of a corresponding digital asset owner, the authenticated agreement also advising the custodian of identifying information for a death reporting entity (processing block 2030); enable the custodian to receive an indication of the death or incapacitation of the digital asset owner from the death reporting entity (processing block 2040); enable the custodian to distribute the digital asset content to the designated recipient platform in response to receiving the indication of the death or incapacitation of the digital asset owner from the death reporting entity (processing block 2050); enable the custodian to receive a first integrity check or authenticated receipt verifying that the designated recipient platform received the distributed digital asset content (processing block 2060); enable the designated recipient platform to distribute the digital asset content to at least one ultimate recipient (processing block 2070); enable the designated recipient platform to receive a second integrity check or authenticated receipt verifying that the at least one ultimate recipient received the distributed digital asset content (processing block 2080); enable the custodian to receive the second integrity check or authenticated receipt verifying that the at least one ultimate recipient received the distributed digital asset content (processing block 2090); enable the designated recipient platform to distribute final arrangements information to at least one ultimate recipient responsible for final arrangements (processing block 2095); and use scheduling software and a data processor to prepare a final arrangements event schedule using the final arrangements information (processing block 2097).

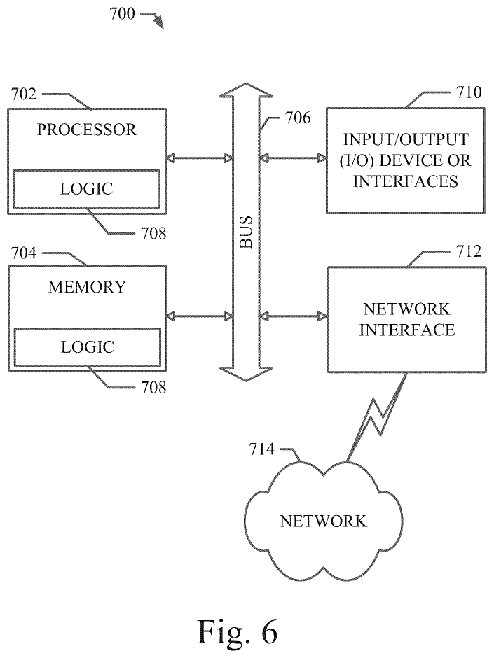

FIG. 6 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a mobile device, a web appliance, a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that stores the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

In the various example embodiments disclosed herein, a system and method for distributing a deceased digital asset owner's digital asset content, using modern cryptography, to a designated recipient pursuant to an online tool the digital asset owner could modify or delete at any time, with added features of drawing on Internet information with AI to help the user plan for final arrangements and the person responsible for carrying out final arrangements purchase the necessary final arrangements goods and/or services, is thereby described. In the various example embodiments described herein, a computer-implemented tool or software application (app) as part of a digital asset distribution system is described to automate and improve the collection, storage, distribution, and verification of digital assets between parties according to the direction of the digital asset owner. As such, the various embodiments as described herein are necessarily rooted in computer processing, data storage, and network technology and serve to improve these technologies when applied in the manner as presently claimed. In particular, the various embodiments described herein improve the use of data storage technology and data network technology in the context of digital asset storage and distribution via electronic means. The various example embodiments as described herein serve to improve data processing, data storage, and network communication technologies when applied in the manner as presently claimed by enabling a deceased digital asset owner to designate the distribution of digital assets according to the highest RUFADAA tier through mandatory disclosure of all content under the online tool as disclosed herein, which is beneficial for custodians because −
1) They can ignore contrary estate planning document disclosure instructions (so no manual document review).
2) They can have a fully automated content distribution process under the online tool.
3) They will have legal cover for information releases in compliance with RUFADAA.
4) They can delete data from servers or move it to a new account after the handoff.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a data processor;
a network interface, in data communication with the data processor, for communication on a data network; and
a digital asset distribution system, executable by the data processor, to:
establish, by use of the data processor and the data network, a data connection with a digital asset owner platform;
establish, by use of the data processor and the data network, a data connection between the digital asset owner platform and an authenticated custodian;
establish, by use of a data processor and a data network, a data connection with a designated recipient platform;
enable, by use of the data processor, the custodian to receive access to digital asset content and distribution instructions from the digital asset owner platform;
enable, by use of the data processor, the custodian to receive an authenticated agreement advising the custodian of identifying information for a designated recipient platform to receive the digital asset content upon death or incapacitation of a corresponding digital asset owner, the authenticated agreement also advising the custodian of identifying information for a death reporting entity;
enable, by use of the data processor, the custodian to receive an indication of the death or incapacitation of the digital asset owner from the death reporting entity;
enable, by use of the data processor, the custodian to distribute the digital asset content to the designated recipient platform in response to receiving the indication of the death or incapacitation of the digital asset owner from the death reporting entity;
enable, by use of the data processor, the custodian to receive a first integrity check or authenticated receipt verifying that the designated recipient platform received the distributed digital asset content;
enable, by use of the data processor, the designated recipient platform to distribute the digital asset content to at least one ultimate recipient;
enable, by use of the data processor, the designated recipient platform to receive a second integrity check or authenticated receipt verifying that the at least one ultimate recipient received the distributed digital asset content;
enable, by use of the data processor, the custodian to receive the second integrity check or authenticated receipt verifying that the at least one ultimate recipient received the distributed digital asset content; and
cause, by use of the data processor, at least a portion of the digital asset content to be expunged from data storage in response to receiving the second integrity check or authenticated receipt.

2. The system of claim 1 being further configured to cryptographically encrypt, by use of the data processor, the digital asset content.

3. The system of claim 1 being further configured to enable, by use of the data processor, the designated recipient platform to receive a decryption key.

4. The system of claim 1 wherein the digital asset content includes information relating to estate planning documents for trust or estate administration, financial assets, liabilities, taxes, insurance, death certificate, final arrangements, obituary, memorial service assets, photographs, song lists, emails, contact lists, last statements, or wishes to family or friends.

5. The system of claim 1 being further configured to enable, by use of the data processor, the digital asset owner to provide authenticated or authenticating credentials or other information empowering the custodian to act on behalf of the digital asset owner with regard to the disclosure or distribution of the digital asset content upon death of the digital asset owner.

6. The system of claim 1 wherein the first integrity check or authenticated receipt includes hashing information corresponding to the digital asset content and the digital asset content is stored using blockchain technology.

7. The system of claim 1 being configured to enable a user to generate final arrangements information with software including artificial intelligence (AI) and Internet data extraction applications and then store the final arrangements information with the custodian as cloud-based encrypted final arrangements digital asset content.

8. A computer-implemented method comprising:
establishing, by use of a data processor and a data network, a data connection with a digital asset owner platform;
establishing, by use of the data processor and the data network, a data connection between the digital asset owner platform and an authenticated custodian;
establishing, by use of a data processor and a data network, a data connection with a designated recipient platform;
enabling, by use of the data processor, the custodian to receive access to digital asset content and distribution instructions from the digital asset owner platform;
enabling, by use of the data processor, the custodian to receive an authenticated agreement advising the custodian of identifying information for a designated recipient platform to receive the digital asset content upon death or incapacitation of a corresponding digital asset owner, the authenticated agreement also advising the custodian of identifying information for a death reporting entity;
enabling, by use of the data processor, the custodian to receive an indication of the death or incapacitation of the digital asset owner from the death reporting entity;
enabling, by use of the data processor, the custodian to distribute the digital asset content to the designated recipient platform in response to receiving the indication of the death or incapacitation of the digital asset owner from the death reporting entity;
enabling, by use of the data processor, the custodian to receive a first integrity check or authenticated receipt verifying that the designated recipient platform received the distributed digital asset content;
enabling, by use of the data processor, the designated recipient platform to distribute the digital asset content to at least one ultimate recipient;
enabling, by use of the data processor, the designated recipient platform to receive a second integrity check or authenticated receipt verifying that the at least one ultimate recipient received the distributed digital asset content;
enabling, by use of the data processor, the custodian to receive the second integrity check or authenticated receipt verifying that the at least one ultimate recipient received the distributed digital asset content;
enabling, by use of the data processor, the designated recipient platform to distribute final arrangements information to at least one ultimate recipient responsible for final arrangements; and
using scheduling software and a data processor to prepare a final arrangements event schedule using the final arrangements information.

9. The method of claim 8 including cryptographically encrypting, by use of the data processor, the digital asset content.

10. The method of claim 8 including enabling, by use of the data processor, the designated recipient platform to receive a decryption key.

11. The method of claim 8 wherein the digital asset content includes information relating to estate planning documents for trust or estate administration, financial assets, liabilities, taxes, insurance, death certificate, final arrangements, obituary, memorial service assets, photographs, song lists, emails, contact lists, last statements, or wishes to family or friends.

12. The method of claim 8 including enabling, by use of the data processor, the digital asset owner to provide authenticated or authenticating credentials or other information empowering the custodian to act on behalf of the digital asset owner with regard to the disclosure or distribution of the digital asset content upon death of the digital asset owner.

13. The method of claim 8 wherein the first integrity check or authenticated receipt includes hashing information corresponding to the digital asset content and the digital asset content is stored using blockchain technology.

14. The method of claim 8 including enabling a user to generate final arrangements information with software including artificial intelligence (AI) and Internet data extraction applications and then store the final arrangements information with the custodian as cloud-based encrypted final arrangements digital asset content.

15. A non-transitory machine-useable storage medium embodying instructions which, when executed by a machine, cause the machine to:
establish, by use of a data processor and a data network, a data connection with a digital asset owner platform;
establish, by use of the data processor and the data network, a data connection between the digital asset owner platform and an authenticated custodian;
establish, by use of a data processor and a data network, a data connection with a designated recipient platform;
enable, by use of the data processor, the custodian to receive access to digital asset content and distribution instructions from the digital asset owner platform;
enable, by use of the data processor, the custodian to receive an authenticated agreement advising the custodian of identifying information for a designated recipient platform to receive the digital asset content upon death or incapacitation of a corresponding digital asset owner, the authenticated agreement also advising the custodian of identifying information for a death reporting entity;
enable, by use of the data processor, the custodian to receive an indication of the death or incapacitation of the digital asset owner from the death reporting entity;
enable, by use of the data processor, the custodian to distribute the digital asset content to the designated recipient platform in response to receiving the indication of the death or incapacitation of the digital asset owner from the death reporting entity;
enable, by use of the data processor, the custodian to receive a first integrity check or authenticated receipt verifying that the designated recipient platform received the distributed digital asset content;
enable, by use of the data processor, the designated recipient platform to distribute the digital asset content to at least one ultimate recipient;
enable, by use of the data processor, the designated recipient platform to receive a second integrity check or authenticated receipt verifying that the at least one ultimate recipient received the distributed digital asset content;
enable, by use of the data processor, the custodian to receive the second integrity check or authenticated receipt verifying that the at least one ultimate recipient received the distributed digital asset content;
enable, by use of the data processor, the designated recipient platform to distribute final arrangements information to at least one ultimate recipient responsible for final arrangements; and
use scheduling software and a data processor to prepare a final arrangements event schedule using the final arrangements information.

16. The non-transitory machine-useable storage medium of claim 15 being further configured to cryptographically encrypt, by use of the data processor, the digital asset content.

17. The non-transitory machine-useable storage medium of claim 15 being further configured to enable, by use of the data processor, the designated recipient platform to receive a decryption key.

18. The non-transitory machine-useable storage medium of claim 15 wherein the digital asset content includes information relating to estate planning documents for trust or estate administration, financial assets, liabilities, taxes, insurance, death certificate, final arrangements, obituary, memorial service assets, photographs, song lists, emails, contact lists, last statements, or wishes to family or friends.

19. The non-transitory machine-useable storage medium of claim 15 being further configured to enable, by use of the data processor, the digital asset owner to provide authenticated or authenticating credentials or other information empowering the custodian to act on behalf of the digital asset owner with regard to the disclosure or distribution of the digital asset content upon death of the digital asset owner.

20. The non-transitory machine-useable storage medium of claim 15 being configured to enable a user to generate final arrangements information with software including artificial intelligence (AI) and Internet data extraction applications and then store the final arrangements information with the custodian as cloud-based encrypted final arrangements digital asset content.
